(19) United States
(12) Patent Application Publication
(10) Pub. No.: US 2024/0257208 A1
(43) Pub. Date: Aug. 1, 2024

(54) PERSONALIZED SEARCH AND BROWSE RANKING WITH CUSTOMER BRAND AFFINITY SIGNAL

(71) Applicant: Walmart Apollo, LLC, Bentonville, AR (US)

(72) Inventors: Jingbo Liu, Princeton, NJ (US); Jie Zhao, Rego Park, NY (US); Junchao Zheng, Jersey City, NJ (US); Jun Zhao, Jersey City, NJ (US); Cun Mu, New York, NY (US); Zheng Yan, Short Hills, NJ (US)

(73) Assignee: Walmart Apollo, LLC, Bentonville, AR (US)

(21) Appl. No.: 18/103,156

(22) Filed: Jan. 30, 2023

(51) Int. Cl. G06Q 30/0601; G06N 20/20

(52) U.S. Cl. CPC G06Q 30/0631; G06N 20/20; G06Q 30/0625

(57) ABSTRACT

A method including receiving a request from a user to view a page. The page is one of a search results page or a browse shelf page. The method also can include obtaining a respective brand affinity score for the user for each of one or more product types associated with the request. The method additionally can include generating a respective brand affinity signal for the user for each respective item in a baseline list of items to be displayed on the page, based on the request and the respective brand affinity score for the user for a product type of the one or more product types associated with the respective item. The method further can include generating a reranking of the items to be displayed on the page, based on a machine learning model and based on factors comprising the respective brand affinity signals for the user for the items and other rerank signals. The method additionally can include outputting the reranking of the items. Other embodiments are described.

### TECHNICAL FIELD

This disclosure relates generally to personalized search and browse ranking with customer brand affinity signal.

### BACKGROUND

Websites that offer items online often show the items on search results pages, such as in response to a search query from a user. Such websites also often show the items on browse pages, such as browse pages that represent categories in a taxonomy of the items. The ranking or ordering of items on the search results pages and/or browse pages is often based on a number of factors, such as relevance of the item to the search query, how well the item sells, etc.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for personalized ranking using affinity score, according to an embodiment;

FIG. 4 illustrates a flow chart for a method of providing personalized ranking for a search page using affinity score, according to another embodiment;

FIG. 5 illustrates a flow chart for a method of providing personalized ranking for a browse page using affinity score, according to another embodiment; and

FIG. 6 illustrates a flow chart for a method of providing personalized ranking using affinity score, according to another embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.1 second, 0.5 second, one second, two seconds, five seconds, or ten seconds.

### DESCRIPTION OF EXAMPLES OF EMBODIMENTS

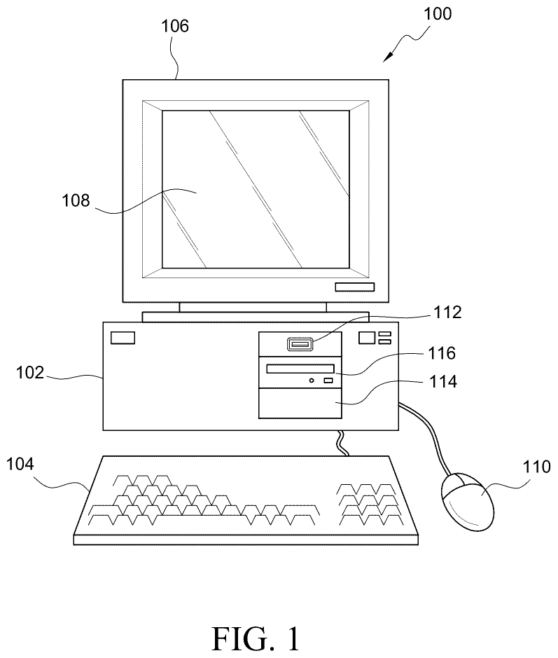

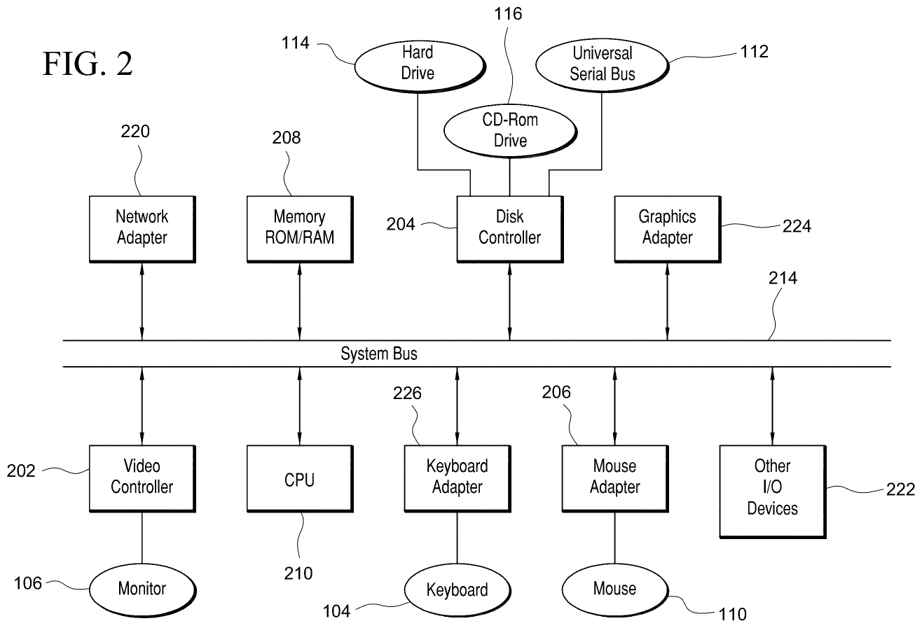

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

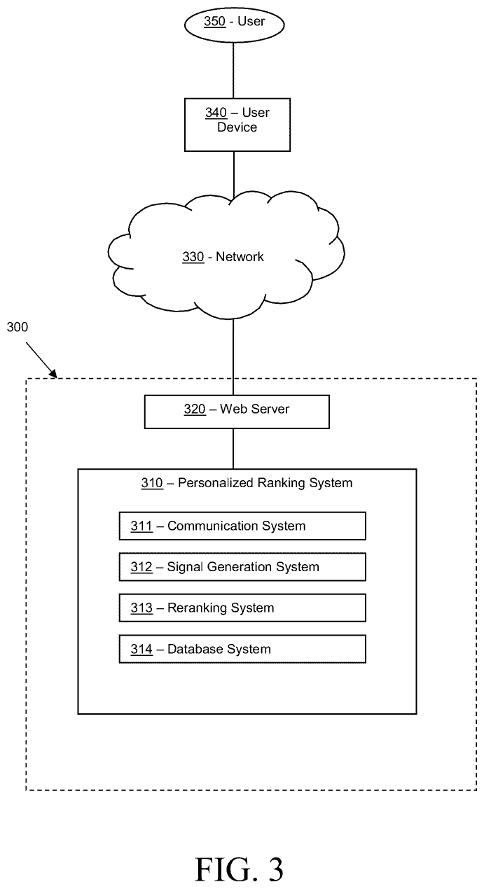

Turning ahead in the drawings, FIG. 3 illustrates a block diagram of a system 300 that can be employed for personalized ranking using affinity score, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include a personalized ranking system 310 and/or a web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Personalized ranking system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host personalized ranking system 310 and/or web server 320. Additional details regarding personalized ranking system 310 and/or web server 320 are described herein.

In some embodiments, web server 320 can be in data communication through a network 330 with one or more user devices, such as a user device 340. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to browse and/or search for items (e.g., products, grocery items), to add items to an electronic cart, and/or to purchase items, in addition to other suitable activities, or to interface with and/or configure personalized ranking system 310.

In some embodiments, an internal network that is not open to the public can be used for communications between personalized ranking system 310 and web server 320 within system 300. Accordingly, in some embodiments, personalized ranking system 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Lumia® or similar product by the Nokia Corporation of Keilaniemi, Espoo, Finland, and/or (iii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Android™ operating system developed by the Open Handset Alliance, or (iii) the Windows Mobile™ operating system by Microsoft Corp. of Redmond, Washington, United States of America.

In many embodiments, personalized ranking system 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to personalized ranking system 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of personalized ranking system 310 and/or web server 320. In a similar manner, the processors and/or the non-transitory computer-readable media can be local and/or remote to each other.

Meanwhile, in many embodiments, personalized ranking system 310 and/or web server 320 also can be configured to communicate with one or more databases, such as a database system 314. The one or more databases can include a product database that contains information about products, items, or SKUs (stock keeping units), for example, among other information, such as browse shelves, as described below in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, personalized ranking system 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, personalized ranking system 310 can include a communication system 311, a signal generation system 312, a reranking system 313, and/or database system 314. In many embodiments, the systems of personalized ranking system 310 can be modules of computing instructions (e.g., software modules) stored at non-transitory computer readable media that operate on one or more processors. In other embodiments, the systems of personalized ranking system 310 can be implemented in hardware. Personalized ranking system 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host personalized ranking system 310 and/or web server 320. Additional details regarding personalized ranking system 310 and the components thereof are described herein.

Convention websites that offer items online often show the items on search results pages (e.g., in response to a search query from a user) and/or on browse pages (e.g., as browse pages that represent categories in a taxonomy of the items). For example, these browse pages can be pages that list items according to the categorical taxonomy of the products. For example, a browse shelf of “Outdoor Griddle Tools & Accessories,” which can have a primary category path within the product taxonomy of “Patio & Garden/Grills & Outdoor Cooking/Outdoor Cooking Tools & Accessories/Outdoor Griddle Tools & Accessories.” The browse page for the browse shelf “Outdoor Griddle Tools & Accessories” can list items that are categorized into that particular category of the product taxonomy. Many browse pages for browse shelves can exist. For example, in some examples, there can be 40,000 different browse shelf pages on the website.

The ranking or ordering of items on the search results pages and/or browse pages is often based on a number of factors, such as relevance of the item to the search query, how well the item sells, etc., but generally not based on personalization for a user, such as a user's brand preferences. For example, a user may have a preference for a particular brand of baby food, such as the “Beech-Nut” brand. When performing a search with the search query “baby food,” the search results on a conventional website may show various items that are baby food, such as the following items in the following order:
1. Gerber My 1st Fruits Baby Food Starter Kit 2 oz Tubs, 6 Count (Pack of 2);
2. Earth's Best Organic Stage 2 Baby Food, Banana Raspberry & Brown Rice, 4.2 oz Pouch, 6 Pack;
3. (Pack of 2) Gerberg 2nd Foods Vanilla Custard Pudding With Bananas Baby Food, 4 oz Tubs;
4. Beech-Nut Naturals Stage 2, Apple Pumpkin & Cinnamon Baby Food, 4 oz Jar;
5. Beech-Nut Naturals Stage 2, Baby Blueberries & Green Beans Baby Food, 4 oz Jar; and
6. Beech-Nut Naturals Stage 2, Carrots Sweet Corn & Pumpkin Baby Food, 4 oz Jar.

As shown in this item list, items that have the preferred brand of the user (i.e., Beech-Nut) do not show up in the top positions of the list.

In a number of embodiments, the techniques described herein can personalize search results pages or browse shelf pages to the user. Users prefer to see their preferred brands showing up at the top of search or browse pages, and such ordering/ranking makes the user's experience more efficient and enjoyable, which can enhance loyalty. In many embodiments, the techniques described herein can learn a good user brand understanding model, can combine a product type prediction score and a user brand affinity score, can leverage an event-level learning-to-rank framework and incorporate the brand affinity score as a ranking signal, can use parallel processing for some calls to reduce latency, and/or can increase overall conversions in search and/or browse. These techniques can rerank the item list described above for the search page, such that Beech-Nut brand items are ranked more prominently, such as in the top positions.

In many embodiments, the techniques described herein can personalize rankings of items on search and/or browse pages based on user preferences for each particular product type. This approach can be used because users often prefer different brands for different product types. For example, a particular user may like a brand (e.g., Nike) for shoes, but may prefer a different brand (e.g., Adidas) for shirts, even though Nike also makes shirts and Adidas also makes shoes.

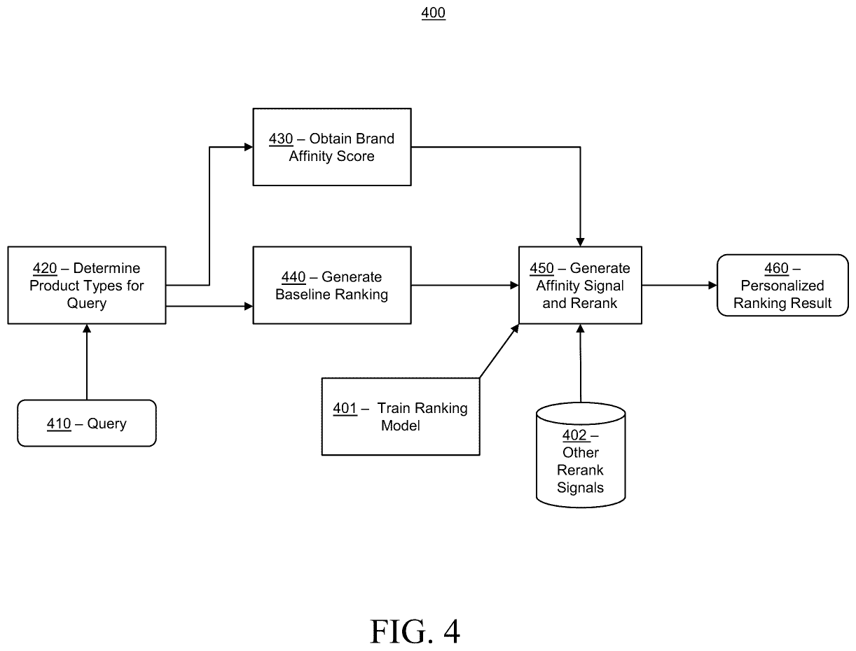

Turning ahead in the drawings, FIG. 4 illustrates a flow chart for a method 400 of providing personalized ranking for a search page using affinity score, according to another embodiment. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, system 300 (FIG. 3), personalized ranking system 310 (FIG. 3), and/or web server 320 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1).

In some embodiments, method 400 and other activities in method 400 can include using a distributed network including distributed memory architecture to perform the associated activity. This distributed architecture can reduce the impact on the network and system resources to reduce congestion in bottlenecks while still allowing data to be accessible from a central location.

As shown in FIG. 4, a query 410 can be received, such as a search query entered by a user using a user device (e.g., user 350 (FIG. 3) using user device 340 (FIG. 3)). In many embodiments, query 410 can be received as input for an activity 420 of determining product types associated with the query. In some embodiments, activity 420 can involve determining the one or more product types that are associated with the query, along with respective confidence scores for each of the product types. A confidence score for a product type can indicate a confidence level that the product type is associated with the query. In some embodiments, this information can be determined through conventional techniques. In various embodiments, activity 420 can involving making an API (application programming interface) call to a service that takes as input the query and returns as output the product types and the confidence scores.

For example, if the query is “battery”, the confidence score for various different product types listed below can be as shown in Table 1:

TABLE 1

| PRODUCT TYPE | CONFIDENCE SCORE |
|---|---|
| “General Purpose Batteries” | 0.9239 |
| “Button Cell Batteries” | 0.5934 |
| “Automotive Batteries” | 0.3379 |
| “Vehicle Batteries” | 0.1917 |
| “Device-Specific Electronics Batteries” | 0.1112 |

In several embodiments, the product types output from activity 420 can be used as inputs to an activity 430 of obtaining brand affinity scores for each of the product types. In many embodiments, a brand affinity score can indicate a likelihood that a user will engage with a particular brand given a certain product type. In some embodiments, this information can be determined through conventional techniques. In some embodiments, activity 430 can involve making an API call to a service that takes as input an identifier for the user and the product type, and returns as output one or more brand affinity scores for one or more brands associated with that product type. For example, for a particular user, the brand affinity score for the product type “General Purpose Batteries” and the brand “Duracell” can be 0.4099.

In a number of embodiments, an activity 440 of generating a baseline ranking can be performed after activity 420 and/or concurrently with activity 420 and/or activity 430. The baseline ranking can provide an initial ranking of the items based on the query. This baseline ranking can be generated by a search engine using conventional techniques. In some embodiments, activity 440 can involve making an API call to a search engine that takes as input the query and returns as output a list of items, such as the top items relevant to the search query. For example, in some embodiments, the top 128 items, or another suitable number of items, can be output from activity 440.

In several embodiments, an activity 450 of generating a brand affinity signal and reranking can be performed after activities 430 and 440. In many embodiments, activity 450 can involve, for each item in the list of items obtained from activity 440, generating the brand affinity signal based on the brand affinity score and a product type score. In some embodiments, the brand affinity signal can be based on multiplying the product type score and the brand affinity score. For example, the brand affinity signal for an item can be calculated as follows:

$$S ( q , i , u ) = {\sum }_{p} {\sum }_{b} ( Conf i dence ( p \vert q ) * Confidence ( b \vert p , u ) * 1 \{ i ∈ ( p , b ) \} ) ,$$

where S is the brand affinity signal, q is the query, i is the item, u is the user, p is the product type, and b is the brand.
Confidence(p|q) is the product type score for product p, and can be a confidence score that product type p is associated with query q. In many embodiments, this product type score can be the confidence score associated with each product type obtained in activity 420.
Confidence(b|p, u) is the brand affinity score for product type p and user u, and can be a confidence score that brand b is preferred by user u for product type p. In many embodiments, the brand affinity score is obtained in activity 430.
1{i∈(p, b)} is an indicator function that indicates whether item i belongs to product type p and brand b, and the output of the indicator function can be 0 or 1, such that the product type score for product type p and the brand affinity score for brand b and product type p contribute to the brand affinity signal when the item i belongs to product type p and brand b. For example, for the examples listed above, in which the query is for “battery,” and the product type of “General Purpose Batteries” which has a product type score of 0.9239, and for which the brand affinity score for the user for the brand “Duracell” in the product type “General Purpose Batteries” is 0.4099, the brand affinity signal S can be calculated as follows:

$$S = 0.9239 * 0.4099 = 0.3797 .$$

In many embodiments, the brand affinity signal S can be calculated in activity 450 for each of the items in the list of items obtained from activity 440. This brand affinity signal can be used along with other rerank signals 402 in a ranking model to rerank the items in the list of items, so that activity 450 can output a personalized ranking result 460. For example, before using the brand affinity signal, the top four items in the search results page for the search query “battery” can be as follows, and in the following order, for a user who prefers the brand “Duracell” for product type “General Purpose Batteries”:
1. Duracell Coppertop AA Battery with POWER BOOST, 24 Pack Long-Lasting Batteries;
2. Rayovac High Energy AAA Batteries (8 Pack), Triple A Batteries;
3. Great Value Alkaline AA Batteries (8 Pack); and
4. Energizer MAX AA Batteries (24 Pack), Double A Alkaline Batteries.

The first item in this list has a brand affinity signal of 0.3787 for the user, and each of the last three items in this list has a brand affinity signal of 0.0 for the user.

After using the brand affinity signal to rerank the items, the top four items in the search results page can be as follows, and in the following order for the user who prefers the brand “Duracell” for product type “General Purpose Batteries”:
1. Duracell Coppertop AA Battery with POWER BOOST, 24 Pack Long-Lasting Batteries;
2. Energizer MAX AA Batteries (24 Pack), Double A Alkaline Batteries;
3. Duracell Coppertop AA Battery with POWER BOOST, 16 Pack Long-Lasting Batteries; and
4. Duracell Coppertop AAA Battery with POWER BOOST, 16 Pack Long-Lasting Batteries.

The first, third, and fourth items in this list have a brand affinity signal of 0.3787 for the user, and the second item in this list has a brand affinity signal of 0.0 for the user.

In many embodiments, an event-level learning-to-rank (LETOR) gradient boosting model can be used as the ranking model to rerank the items in the item list based on the brand affinity signals for the items and rerank signals 402. In many embodiments, in this method 400 for search, the model used in activity 450 can be an XGBoost tree model that optimizes list-wise loss. The model can enable personalized search ranking, by inputting a ranked listed of items, the brand affinity signals, and other rerank signals, and outputting a different ranking for the items for a user based on the brand affinity signals and the rerank signals.

An activity 401 of training the ranking model can occur offline before activities 420-450 are performed online for query 410 by a user (e.g., 350 (FIG. 3)). The ranking model can be trained based on raw search events. Engagement data can be used output of the training data, and can be obtained from historical search data that links search results with engagement results for those search results. The input of the training data can be features, such as the brand affinity signals and other rerank signals 402. In many embodiments, the brand affinity signal for the training data can be generated similarly as described above for online generation of the brand affinity signals. For example, user and product type pairs can be generated from the event-level search result data. The brand affinity scores can be generated for each combination of (user, product type, and item). The brand affinity score can be used to generate the brand affinity signal for each combination of (query, item, and user). The training group can be formed by combining the search request level engagement data and the features. The ranking model, once trained, can be uploaded for use at runtime.

In a number of embodiments, other rerank signals 402 can include query-level signals, item-level signals, query-item-level signals, and/or other suitable signals, which can be conventional rerank signals. For example, other rerank signals 402 can include signals for popularity of the item, attributes, brand match with product type and items, price, text relevance, engagement (clicks, add to carts, conversions, etc.), trends, etc.

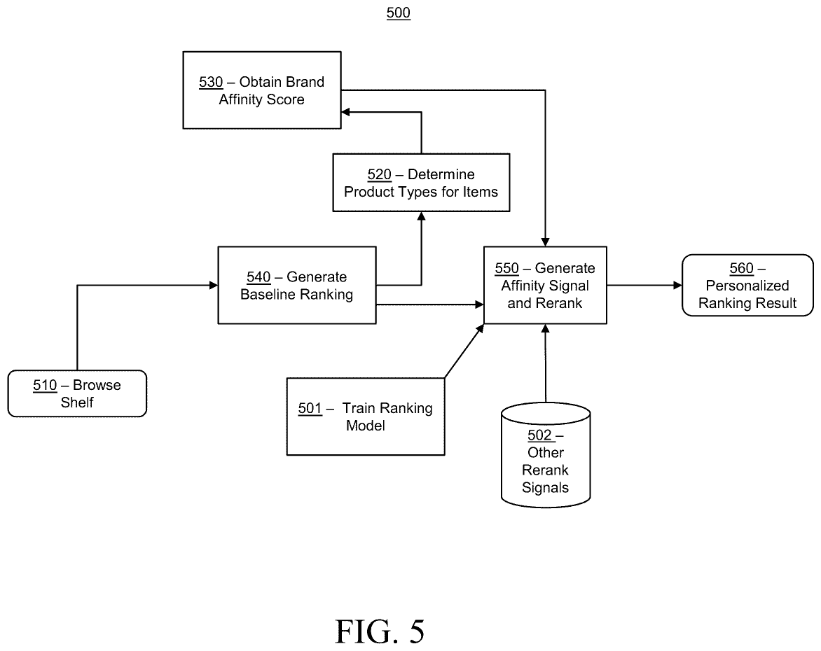

Turning ahead in the drawings, FIG. 5 illustrates a flow chart for a method 500 of providing personalized ranking for a browse page using affinity score, according to another embodiment. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped. Method 500 can be similar to method 400 (FIG. 4), and various activities of method 500 can be similar or identical to various activities of method 400 (FIG. 4).

In many embodiments, system 300 (FIG. 3), personalized ranking system 310 (FIG. 3), and/or web server 320 (FIG. 3) can be suitable to perform method 500 and/or one or more of the activities of method 500. In these or other embodiments, one or more of the activities of method 500 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1).

In some embodiments, method 500 and other activities in method 500 can include using a distributed network including distributed memory architecture to perform the associated activity. This distributed architecture can reduce the impact on the network and system resources to reduce congestion in bottlenecks while still allowing data to be accessible from a central location.

As shown in FIG. 5, a browse shelf 510 can be received, such as an identifier of a shelf for the browse page that is requested a user using a user device (e.g., user 350 (FIG. 3) using user device 340 (FIG. 3)). In many embodiments, browse shelf 510 can be received as input for an activity 550

In several embodiments, browse shelf 510 can be used as an input to an activity 540 of generating a baseline ranking, which can provide an initial ranking of the items to be displayed in the browse page for the browse shelf. This baseline ranking can be generated using conventional techniques. In some embodiments, activity 540 can involve making an API call to a service that takes as input the browse page and returns as output a list of items, such as the top items for the browse page. For example, in some embodiments, the top 256 items, or another suitable number of items, can be output from activity 540. Activity 540 can be similar to activity 440 (FIG. 4), but can be based on the browse shelf instead of the search query.

In a number of embodiments, the list of items output from activity 540 can be used as input into an activity 520 of determining product types associated with the items in the list of items. In some embodiments, the product types can be the product types of the items in the list of items. Activity 520 can be similar to activity 420 (FIG. 4), but can be based on the items in the item list instead of the search query.

In several embodiments, the product types that are output from activity 520 can be used as inputs to an activity 530 of obtaining brand affinity scores for each of the product types. Activity 530 can be similar or identical to activity 430 (FIG. 4).

In various embodiments, an activity 550 of generating a brand affinity signal and reranking can be performed after activities 540, 520, and 530. In many embodiments, activity 550 can involve, for each item in the list of items obtained from activity 540, generating the brand affinity signal based on the brand affinity score. In some embodiments, the brand affinity signal can use the brand affinity score. For example, the brand affinity signal for an item can be calculated as follows:

$$S ( s , i , u ) = {\sum }_{p} {\sum }_{b} ( 1 \{ p ∈ s \} * Confidence ( b \vert p , u ) * 1 \{ i ∈ ( p , b ) \} ) ,$$

where S is the brand affinity signal, s is the browse shelf, i is the item, u is the user, p is the product type, and b is the brand.
1{p∈s} is an indicator function that indicates whether item product type p is included on the items of shelf s. In many embodiments, this information about what product types are part of shelf s is determined in activity 520.
Confidence(b|p, u) is the brand affinity score for product type p and user u, and can be a confidence score that brand b is preferred by user u for product type p. In many embodiments, the brand affinity score is obtained in activity 530.
1{i∈(p, b)} is an indicator function that indicates whether item i belongs to product type p and brand b. In many embodiments, the output of the indicator functions can be 0 or 1 in each case, such that the brand affinity score for brand b contributes to the brand affinity signal when (i) the item i belongs to product type p and brand b, and (ii) the product type p is on the shelf s. Activity 550 can be similar to activity 450 (FIG. 4), but can put less restriction on the product type, and not use the product type score, as the browse experience is typically preferred by users to be more explorative than a search experience, as searches are often targeted.

In many embodiments, the brand affinity signal S can be calculated in activity 550 for each of the items in the list of items obtained from activity 540. This brand affinity signal can be used along with other rerank signals 502 in a ranking model to rerank the items in the list of items, so that activity 550 can output a personalized ranking result 560.

For example, before using the brand affinity signal, the top eight items in the browse shelf page for the browse shelf “Baby/Diapering/Diapers/Training Pants” can be as follows, and in the following order, for a user who prefers the brand “Parent's Choice” for product type “Toilet Training Pants” (with a brand affinity signal of 0.8912):
1. Babmo Dreamy Night Pants for Girls, Size Large, Ages 8 to 15, 30 Ct;
2. Fisher-Price Training Pants 4T-5T (Boy) 96 ct;
3. Fisher-Price Training Pants 4T-5T (Girl) 96 ct;
4. Parent's Choice Girls Training Pants (Choose Your Size & Count);
5. Pull-Ups Boys Potty Training Pants (Choose Your Size & Count);
6. Pull-Ups Girls' Potty Training Pants (Choose Your Size & Count);
7. Kanga Care Lil Learnerz Reusable Swim and Toilet Training Pants (XSmall—Block Party & Scarlet); and
8. Pampers Easy Ups Boys Training Pants (Choose Your Size & Count).

Other than the fourth item in the list (which has a brand affinity signal of 0.8912 for the user), all the other items in this list have a brand affinity signal of 0.0 for the user.

After using the brand affinity signal to rerank the items, the top eight items in the browse shelf page can be as follows, and in the following order for the user who prefers the brand “Parent's Choice” for product type “Toilet Training Pants”:
1. Babmo Dreamy Night Pants for Girls, Size Large, Ages 8 to 15, 30 Ct;
2. Fisher-Price Training Pants 4T-5T (Boy) 96 ct;
3. Fisher-Price Training Pants 4T-5T (Girl) 96 ct;
4. Parent's Choice Girls Training Pants (Choose Your Size & Count);
5. Pull-Ups Boys Potty Training Pants (Choose Your Size & Count);
6. Pull-Ups Girls' Potty Training Pants (Choose Your Size & Count);
7. Kanga Care Lil Learnerz Reusable Swim and Toilet Training Pants (XSmall—Block Party & Scarlet); and
8. Parent's Choice Nightime Underwear (Choose Your Size & Count).

Other than the fourth and eighth items in the list (which has a brand affinity signal of 0.8912 for the user), all the other items in this list have a brand affinity signal of 0.0 for the user.

In many embodiments, an event-level learning-to-rank (LETOR) gradient boosting model can be used as the ranking model to rerank the items in the item list based on the brand affinity signals for the items and other rerank signals 502. In many embodiments, in this method 500 for browse, the model used in activity 550 can be an XGBoost linear model that optimizes pair-wise loss. The model can enable personalized browse ranking, by inputting a ranked listed of items, the brand affinity signals, and other rerank signals, and outputting a different ranking for the items for a user based on the brand affinity signals and the rerank signals. Activity 550 can be similar to activity 450 (FIG. 4), but can be for the browse model (e.g., XGBoost linear model) instead of the search model (XGBoost tree model). In many embodiments, there can be fewer features used in the browse model than the search model.

In many embodiments, an activity 501 of training the ranking model can occur offline before activities 520-550 are performed online for browse shelf 510 by a user (e.g., 350 (FIG. 3)). Activity 501 can be similar to activity 401 (FIG. 4), but can be for the browse model (e.g., XGBoost linear model) instead of the search model (XGBoost tree model), and can be based on raw browse events.

Other rerank signals 502 can be can be similar to other rerank signals 402 (FIG. 4), and can include query-level signals, item-level signals, query-item-level signals, and/or other suitable signals, which can be conventional rerank signals. In many embodiments, some or all of other rerank signals 502 can be different from some or all of rerank signals 402 (FIG. 4). In many embodiments, there can be fewer other rerank signals 502 (e.g., approximately 10 signals) compared to other rerank signals 402 (FIG. 4) (e.g., approximately 60 signals).

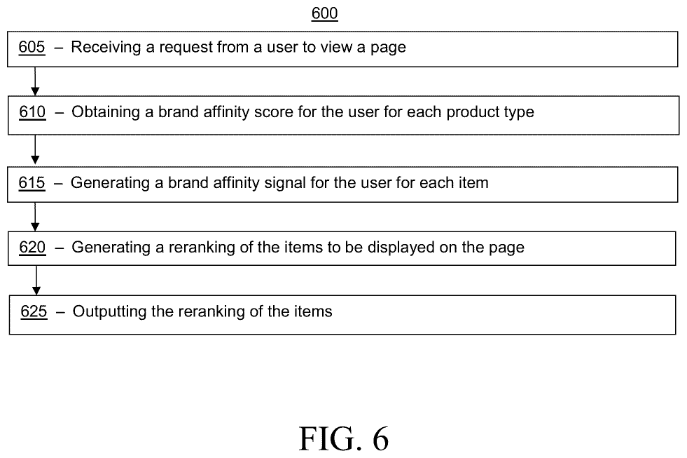

Turning ahead in the drawings, FIG. 6 illustrates a flow chart for a method 600 of providing personalized ranking using affinity score, according to another embodiment. Method 600 is merely exemplary and is not limited to the embodiments presented herein. Method 600 can be employed in many different embodiments or examples not specifically depicted or described herein. In some embodiments, the procedures, the processes, and/or the activities of method 600 can be performed in the order presented. In other embodiments, the procedures, the processes, and/or the activities of method 600 can be performed in any suitable order. In still other embodiments, one or more of the procedures, the processes, and/or the activities of method 600 can be combined or skipped.

In many embodiments, system 300 (FIG. 3), personalized ranking system 310 (FIG. 3), and/or web server 320 (FIG. 3) can be suitable to perform method 600 and/or one or more of the activities of method 600. In these or other embodiments, one or more of the activities of method 600 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1).

In some embodiments, method 600 and other activities in method 600 can include using a distributed network including distributed memory architecture to perform the associated activity. This distributed architecture can reduce the impact on the network and system resources to reduce congestion in bottlenecks while still allowing data to be accessible from a central location.

Referring to FIG. 6, method 600 can include an activity 605 of receiving a request from a user to view a page. The user can be similar or identical to user 350 (FIG. 3). In many embodiments, the page can be one of a search results page or a browse shelf page. For example, when the request is a search request, the page is the search results page. Alternatively, the request is a browse request, the page is the browse shelf page. In many embodiments, communication system 311 (FIG. 3) can at least partially perform activity 605.

In a number of embodiments, method 600 also can include an activity 610 of obtaining a respective brand affinity score for the user for each of one or more product types associated with the request. The brand affinity score can be similar or identical to the brand affinity score described above in connection with activity 430 (FIG. 4) of obtaining brand affinity scores and/or activity 530 (FIG. 5) of obtaining brand affinity scores. In many embodiments, communication system 311 (FIG. 3) can at least partially perform activity 610.

In some embodiments, the one or more product types associated with the request can be determined based on a search query of the search request. The search query can be similar or identical to query 410 (FIG. 4). In other embodiments, the one or more product types associated with the request can be determined based on product types for items associated with a browse shelf identifier of the browse request. The browse shelf identifier can be similar or identical to browse shelf 510 (FIG. 5).

In several embodiments, method 600 additionally can include an activity 615 of generating a respective brand affinity signal for the user for each respective item in a baseline list of items to be displayed on the page, based on the request and the respective brand affinity score for the user for a product type of the one or more product types associated with the respective item. The brand affinity signal can be similar or identical to the brand affinity signal generated in activity 450 (FIG. 4) of generating a brand affinity signal and reranking, and/or activity 550 (FIG. 5) of generating a brand affinity signal and reranking. The baseline list of items can be similar or identical to the list of items generated in an activity 440 (FIG. 4) of generating a baseline ranking and/or activity 540 (FIG. 5) of generating a baseline ranking. In many embodiments, signal generation system 312 (FIG. 3) can at least partially perform activity 615.

In some embodiments, such as when the request is a search request, activity 615 can include generating the respective brand affinity signal for the user for each respective item in the baseline list of items based on a product type score for the product type associated with the respective item and the respective brand affinity score for the user for the product type associated with the respective item. The product type score can be similar or identical to the confidence score described in activity 420 (FIG. 4) of determining product types associated with the query and/or the product type score described in activity 450 (FIG. 4) of generating a brand affinity signal and reranking.

In other embodiments, such as when the request is a browse request, activity 615 can include generating the respective brand affinity signal for the user for each respective item in the baseline list of items based on the respective brand affinity score for the user for the product type associated with the respective item.

In a number of embodiments, method 600 further can include an activity 620 of generating a reranking of the items to be displayed on the page, based on a machine learning model and based on factors comprising the respective brand affinity signals for the user for the items and other rerank signals. In some embodiments, the reranking can be similar or identical to the reranking described above in connection with activity 450 (FIG. 4) of generating a brand affinity signal and reranking, and/or activity 550 (FIG. 5) of generating a brand affinity signal and reranking. In many embodiments, the other rerank signals can include one or more of: (i) one or more query-level signals; (ii) one or more item-level signals; and/or (iii) one or more query-item-level signals. In many embodiments, reranking system 313 (FIG. 3) can at least partially perform activity 620.

In many embodiments, the machine learning model comprises an XGBoost tree model when the request is a search request. In many embodiments, the XGBoost tree model is trained before receiving the search request. In many embodiments, the machine learning model comprises an XGBoost linear model when the request is a browse request. In many embodiments, the XGBoost linear model is trained before receiving the browse request.

In several embodiments, method 600 additionally can include an activity 625 of outputting the reranking of the items. For example, the reranking can be output to a service that generates the browse page and/or the search page, which can be sent for display to the user on a user device (e.g., 340 (FIG. 3)). In many embodiments, communication system 311 (FIG. 3) can at least partially perform activity 625.

In many embodiments, the techniques described herein can provide a practical application and several technological improvements. In some embodiments, the techniques described herein can provide for personalized ranking using affinity score. The techniques described herein can provide a significant improvement over conventional approaches that fail to take into account personal preferences of the users. In some embodiments, the techniques described herein can leverage product type score with brand affinity understanding to enhance the signal confidence. For example, on the search side, the product type score from query understanding is combined with brand affinity understanding, such that the final brand affinity signal used in search rerank model is more accurate under certain product types, which facilitates elevating more relevant and personalized recommendations for the users at higher positions of search results. On the browse side, brand affinity understanding is used as the signal, with the understanding that users are usually in an explorative mode and there is less advantage to restricting the product type

In some embodiments, the techniques described herein can use parallel API calls, such as to obtain the brand affinity score and to generate the baseline ranking in search. The API call to obtain the brand affinity score can be make right after obtaining the product type prediction and before the baseline ranking, such that the brand affinity result is obtained before calling the rerank service. As a consequence, no extra latency is introduced.

In some embodiments, the techniques described herein can exploit the product type context of items after the browse baseline ranking. Product type understanding prior to baseline ranking is not available for browse shelves but can be obtained for the API call to obtain the brand affinity score based on determining the product types of the items. In this way, the PT information can be obtained, and the API calls to obtain the brand affinity score can be implemented as asynchronous and non-blocking to ensure minimal impact on runtime latency.

In a number of embodiments, the techniques described herein can solve a technical problem that arises only within the realm of computer networks, as online ordering is a concept that do not exist outside the realm of computer networks. Moreover, the techniques described herein can solve a technical problem that cannot be solved outside the context of computer networks. Specifically, the techniques described herein cannot be used outside the context of computer networks, in view of a lack of data, the lack of search result pages and/or browse shelf pages outside computer networks, and the inability to perform machine learning models without a computer.

Various embodiments can include a system including one or more processors and one or more non-transitory computer-readable media storing computing instructions that, when executed on the one or more processors, cause the one or more processors to perform certain acts. The acts can include receiving a request from a user to view a page. The page is one of a search results page or a browse shelf page. The acts also can include obtaining a respective brand affinity score for the user for each of one or more product types associated with the request. The acts additionally can include generating a respective brand affinity signal for the user for each respective item in a baseline list of items to be displayed on the page, based on the request and the respective brand affinity score for the user for a product type of the one or more product types associated with the respective item. The acts further can include generating a reranking of the items to be displayed on the page, based on a machine learning model and based on factors comprising the respective brand affinity signals for the user for the items and other rerank signals. The acts additionally can include outputting the reranking of the items.

A number of embodiments can include a method being implemented via execution of computing instructions configured to run at one or more processors. The method can include receiving a request from a user to view a page. The page is one of a search results page or a browse shelf page. The method also can include obtaining a respective brand affinity score for the user for each of one or more product types associated with the request. The method additionally can include generating a respective brand affinity signal for the user for each respective item in a baseline list of items to be displayed on the page, based on the request and the respective brand affinity score for the user for a product type of the one or more product types associated with the respective item. The method further can include generating a reranking of the items to be displayed on the page, based on a machine learning model and based on factors comprising the respective brand affinity signals for the user for the items and other rerank signals. The method additionally can include outputting the reranking of the items.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although personalized ranking using affinity score has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments. For example, one or more of the procedures, processes, or activities of FIG. 4-6 may include different procedures, processes, and/or activities and be performed by many different modules, in many different orders, and/or one or more of the procedures, processes, or activities of FIGS. 4-6 may include one or more of the procedures, processes, or activities of another different one of FIGS. 4-6. As another example, the systems within system 300 (FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, cause the one or more processors to perform:
receiving a request from a user to view a page, wherein the page is one of a search results page or a browse shelf page;
obtaining a respective brand affinity score for the user for each of one or more product types associated with the request;
generating a respective brand affinity signal for the user for each respective item in a baseline list of items to be displayed on the page, based on the request and the respective brand affinity score for the user for a product type of the one or more product types associated with the respective item;
generating a reranking of the items to be displayed on the page, based on a machine learning model and based on factors comprising the respective brand affinity signals for the user for the items and other rerank signals; and
outputting the reranking of the items.

2. The system of claim 1, wherein:
the page is the search results page;
the request is a search request; and
the one or more product types associated with the request are determined based on a search query of the search request.

3. The system of claim 1, wherein:
the page is the browse shelf page;
the request is a browse request; and
the one or more product types associated with the request are determined based on product types for items associated with a browse shelf identifier of the browse request.

4. The system of claim 1, wherein generating the respective brand affinity signal for the user for each respective item in the baseline list of items further comprises:
generating the respective brand affinity signal for the user for each respective item in the baseline list of items based on a product type score for the product type associated with the respective item and the respective brand affinity score for the user for the product type associated with the respective item when the request is a search request.

5. The system of claim 1, wherein generating the respective brand affinity signal for the user for each respective item in the baseline list of items further comprises:
generating the respective brand affinity signal for the user for each respective item in the baseline list of items based on the respective brand affinity score for the user for the product type associated with the respective item when the request is a browse request.

6. The system of claim 1, wherein the other rerank signals comprise one or more of:
one or more query-level signals;
one or more item-level signals; or
one or more query-item-level signals.

7. The system of claim 1, wherein the machine learning model comprises an XGBoost tree model when the request is a search request.

8. The system of claim 7, wherein the XGBoost tree model is trained before receiving the search request.

9. The system of claim 1, wherein the machine learning model comprises an XGBoost linear model when the request is a browse request.

10. The system of claim 9, wherein the XGBoost linear model is trained before receiving the browse request.

11. A method implemented via execution of computing instructions configured to run at one or more processors, the method comprising:
receiving a request from a user to view a page, wherein the page is one of a search results page or a browse shelf page;
obtaining a respective brand affinity score for the user for each of one or more product types associated with the request;
generating a respective brand affinity signal for the user for each respective item in a baseline list of items to be displayed on the page, based on the request and the respective brand affinity score for the user for a product type of the one or more product types associated with the respective item;
generating a reranking of the items to be displayed on the page, based on a machine learning model and based on factors comprising the respective brand affinity signals for the user for the items and other rerank signals; and
outputting the reranking of the items.

12. The method of claim 11, wherein:
the page is the search results page;
the request is a search request; and
the one or more product types associated with the request are determined based on a search query of the search request.

13. The method of claim 11, wherein:
the page is the browse shelf page;
the request is a browse request; and
the one or more product types associated with the request are determined based on product types for items associated with a browse shelf identifier of the browse request.

14. The method of claim 11, wherein generating the respective brand affinity signal for the user for each respective item in the baseline list of items further comprises:
generating the respective brand affinity signal for the user for each respective item in the baseline list of items based on a product type score for the product type associated with the respective item and the respective brand affinity score for the user for the product type associated with the respective item when the request is a search request.

15. The method of claim 11, wherein generating the respective brand affinity signal for the user for each respective item in the baseline list of items further comprises:
generating the respective brand affinity signal for the user for each respective item in the baseline list of items based on the respective brand affinity score for the user for the product type associated with the respective item when the request is a browse request.

16. The method of claim 11, wherein the other rerank signals comprise one or more of:
one or more query-level signals;
one or more item-level signals; or
one or more query-item-level signals.

17. The method of claim 11, wherein the machine learning model comprises an XGBoost tree model when the request is a search request.

18. The method of claim 17, wherein the XGBoost tree model is trained before receiving the search request.

19. The method of claim 11, wherein the machine learning model comprises an XGBoost linear model when the request is a browse request.

20. The method of claim 19, wherein the XGBoost linear model is trained before receiving the browse request.
